(19) United States
(12) Patent Application Publication
(10) Pub. No.: US 2006/0272534 A1
(43) Pub. Date: Dec. 7, 2006

(54) Systems and methods for printing surface relief structures

(76) Inventor: Daniel Lieberman, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/144,349

(22) Filed: Jun. 3, 2005

(51) Int. Cl. B41F 5/00

(52) U.S. Cl. 101/487; 101/216; 101/491

(57) ABSTRACT

The present invention provides a system for printing surface relief structures onto a substrate, wherein the system comprises an anilox roller carrying a high refractive index material, a surface relief tool, a flexographic tool including raised features for picking up the high refractive index material from the anilox roller and depositing the high refractive index material onto the surface relief tool, and a curing tool that cures the high refractive index material in a single pass as the substrate is pressed against the surface relief tool. The surface relief structures may be printed in register to conventional printing being done on the same equipment.

### FIELD OF THE INVENTION

The present invention is directed to surface relief structures, and more particularly to, systems and methods for printing surface relief structures using conventional printing equipment.

### BACKGROUND OF THE INVENTION

Conventional holographic surface reliefs are manufactured by slow embossing and casting processes that are separate from mainstream printing processes. For example, the processes may involve embossing onto pre-metallized materials or casting onto clear films and papers, and then metallizing the embossed materials.

The above-described embossing and casting processes suffer from a number of known drawbacks, including: (1) the processes are not suitable for use with the printing equipment; (2) embossing or casting in localized regions is not possible with conventional metallizing equipment; (3) the metallizing equipment is prohibitively expensive; (4) printing onto the embossed and metalized material is very slow and expensive; (5) conventional embossing and casting systems are much slower than printing equipment; (6) it is difficult to overprint onto a holographic substrate when perfect registration is required; (7) holographic substrates may cover the entire face of the substrate, which may be a problem if the final product is a label, package or security document; and (8) holographic hot-stamping and cold-stamping substrates may have to be added to the printing in attachments placed on the conventional printing equipment.

Some prior art systems have attempted to cure some of the above-identified drawbacks by curing holograms with ultra-violet/electron beam (UV/EB) curing systems or other forms of electromagnetic radiation, and then applying vacuum evaporated aluminum onto the hologram using an online printing process. However, such systems have failed due to the difficulty of maintaining a proper vacuum for aluminum deposition in a printing process that requires an air-to-air vacuum metallizer. Additionally, these systems are very complex and expensive, and require at least two additional steps including curing the hologram and metallizing the hologram. Other prior art systems utilize process for casting nano-, micro-, and macro-structures at high speeds. However, such processes often result in surface relief distortions.

Holograms or surface relief structures may be printed such that they become reflective, semi-reflective or non-reflective in a single pass through a printing station. Reflective surface reliefs may include one or more of the following additional drawbacks. One drawback of reflective surface reliefs is that the quality of the metallic ink may not be as reflective as desired because the metallic particles that are mixed into the pigment do not properly align themselves according to the planar features of the substrate and the surface relief. Such a phenomenon is common when using UV/EB curable metallic inks. This results in a dulling of the surface relief image and leafing problems that require the application of a protective coating. Another drawback of reflective surface reliefs is that the thickness of the metallic coating diminishes the holographic effect. In vacuum metallizing, the metallic coating measures between 300 to 500 Angstroms, whereas in printing systems it is around 1 to 2 microns or more than the embossing depth of about 0.2 microns. This relatively thick coating tends to obliterate the brightness and efficiency of the surface relief.

In order for nano-, micro-, and macro-structures to become more widely used in mainstream labeling and packaging applications, it is necessary to be able to print these structures with existing printing methods. This will enable printing at high speeds, at required widths, and in register with the conventional printing on the label, package or document being printed.

European Patent EP1150843 discloses a method and device for rotational molding of surface relief structures to a substrate using a conventional printing machine. The method comprises the steps of: applying a curable lacquer onto the substrate using a flexographic tool; pre-curing the curable lacquer; passing the substrate through a molding station; adjusting the embossing tool to the pre-cured lacquer; and post-curing the lacquer. One drawback of this patent is that the method of the invention requires two or more curing steps to cure the lacquer. Additionally, the post-curing step may create problems in the resolution of the surface features because the features will start to degrade as soon as the substrate leaves the molding station until they are 100% cured. A further drawback is that the invention does not envision the use of metallic inks and lacquers to make the structures reflective without the use of expensive vacuum metallizing equipment.

Another drawback of the above-identified European patent is that it does not disclose the use of high diffractive index transparent inks and lacquers in order to avoid rendering the structure invisible when it is overprinted or overlaminated. An additional drawback is that the device of the invention is based on old-fashioned gear systems rather than contemporary gearless devices. The old-fashioned gear systems use cylinders of different diameters to achieve variable printing lengths, whereas, with a gearless press it is possible to have different printing lengths without changing the diameters of the cylinders. Yet another drawback is that the preferred molding material is a transparent elastomer made of Polydimetylsiloxane (PDMS), which degrades quickly with electromagnetic radiation.

U.S. Patent Publication No. 2004/0166336 discloses the use of a metallic substrate as a base, and then coating the substrate with a transparent embossable lacquer using the reflective properties of the metal substrate. Some drawbacks of this reference are that: (1) it does not disclose the use of a high refractive layer; (2) the base substrate is metallic; (3) it involves printing in layers rather than printing in register; and (4) it does not involve applying selective holography.

In view of the above, there exists a need for systems and methods for printing surface relief structures that fully incorporates surface relief technologies into mainstream printing applications such as flexible and rigid packaging, labels, and printed forms.

There also exists a need for systems and methods for printing surface relief structures that allows embossing or casting of the surface relief, and metallizing of the surface relief using a conventional printing system such as flexography, rotogravure, offset printing, silkscreen printing, digital printing, and ink jet printing.

There further exists a need for systems and methods for printing surface relief structures that are incorporated onto printed substrates at the same speeds as conventional printing processes and in perfect registration to conventional printing on the same printing equipment.

Additionally, there exists a need for systems and methods for printing surface relief structures including a chilling station at which a UV/EB metallic high refractive coating is cured in a single curing step, wherein the chilling station is designed to prevent substrate and surface relief distortions

There also exists a need for systems and methods for printing surface relief structures that are compatible with reverse printing techniques.

### SUMMARY OF THE INVENTION

In view of the foregoing, it is an object of the present invention to provide systems and methods for printing surface relief structures that fully incorporates surface relief technologies into mainstream printing applications such as flexible and rigid packaging, labels, and printed forms.

It is a further object of the invention to provide systems and methods for printing surface relief structures that allows embossing or casting of the surface relief, and metallizing of the surface relief using a conventional printing system such as flexography, rotogravure, offset printing, silkscreen printing, digital printing, and ink jet printing.

It is another object of the invention to provide systems and methods for printing surface relief structures that are incorporated onto printed substrates at the same speeds as conventional printing processes and in perfect registration to conventional printing on the same printing equipment.

It is a further object of the invention to provide a systems and methods for printing surface relief structures including a chilling station at which a UV/EB metallic high refractive coating is cured in a single curing step, wherein the chilling station is designed to prevent substrate and surface relief distortions.

It is yet another object of the invention to provide systems and methods for printing surface relief structures that are compatible with reverse printing techniques.

The present invention provides a system for printing surface relief structures onto a substrate, wherein the system comprises an anilox roller carrying a high refractive index material, a surface relief tool, a flexographic tool including raised features for picking up the high refractive index material from the anilox roller and depositing the high refractive index material onto the surface relief tool, and a curing tool that cures the high refractive index material in a single pass as the substrate is pressed against the surface relief tool.

According to an aspect of the invention, the anilox roller is maintained at a predetermined temperature in order to induce metallic particles within the high refractive index material to align substantially parallel to a major surface of the substrate. According to another aspect of the invention, the surface relief tool includes a chilled casting roller for maintaining the substrate at a predetermined temperature. The surface relief tool may be selected from the group consisting of: a nickel sleeve; a nickel plate; an etched metallic drum; a clear plastic film; a clear embossed plastic plate; and a clear plastic plate.

According to a further aspect of the invention, the flexographic tool comprises a flexographic printing sleeve or plate attached to a master roller that is temperature controlled to a predetermined temperature, wherein the flexographic tool deposits the high refractive index material onto the surface relief tool in substantially perfect register to the surface relief structures in the surface relief tool. The curing tool is used to direct electromagnetic radiation through the substrate as the substrate is being chilled. The preferred system of the invention preferably comprises a temperature-controlled tray containing the high refractive index material, wherein the temperature-controlled tray is designed to feed the anilox roller.

The present invention also provides several methods for producing reflective surface relief structures. One such method involves the use of a high refractive index material that comprises a UV/EB ink or lacquer including metallic particles that become aligned substantially parallel to the surface of the substrate upon curing. In some embodiments, the high refractive index material includes metal particles for producing a metallic coating, wherein the high refractive index material including metal particles is heated to a predetermined temperature that allows the particles to settle substantially parallel to the substrate when being cured.

Another method for producing reflective surface relief structures involves applying metallic ink and or lacquer that it is cured against a mirror finish chilled roller at a first station. Then, at a second station, a high reflective index ink and/or lacquer is cured on top of the mirror finish. Alternatively hot-stamping or cold-stamping metallized foils may be used as the mirror base at the first station, and then the high reflective index ink and/or lacquer is cast and applied onto the already placed metallic finish. The hot-stamping is applied at the first station with a hot-stamping rotary attachment using heat and pressure, whereas the cold-stamping is applied on the first station by first applying a cold stamping adhesive and laminating the foil to it. In either case, the foils are applied to the surface of the substrate in the exact shape and location that the holography will have on top of them.

The system of the invention may be used for the manufacture of: holographic conductive antennas; holographic shrink-wrap films; transfer films; heat transfer films; or foils that already contain multicolor printing and surface relief effects in register to each other. Advantageously, the surface relief structures may be printed on either major surface of the substrate. According to some embodiments of the invention, the surface relief structures are printed such that they overlap ink printing on the substrate in substantially perfect register. According to other embodiments of the invention, the surface relief structures are printed such that they do not overlap ink printing on the substrate. According to additional embodiments of the invention, the surface relief structures are printed as a continuous wallpaper pattern with no registration requirement.

### BRIEF DESCRIPTION OF THE DRAWINGS

FIG. 1 illustrates the use of conventional printing equipment to print both conventional ink-based images and surface relief structures onto a substrate;

FIG. 2 depicts a preferred system of printing surface relief structures on a substrate using conventional printing equipment, in accordance with the principles of the present invention;

FIGS. 3A-3C are perspective views illustrating the substrate after a metallic base layer coated with a high refractive index material layer having surface relief structures is applied thereto; and

FIG. 4 depicts preferred system of printing mirrored surface relief structures on a substrate using conventional printing equipment, in accordance with the principles of the present invention.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

Structures that exhibit surface reliefs of more than 10 nanometers to less than 3 millimeters in depth and width can now be “printed” or cast (cured) in conventional or digital printing equipment with perfect registration to the other printing stations. Such structures include nano-structures, micro-structures and macro-structures that may be optical or non-optical structures. For example, holograms can now be printed such that they become reflective, semi-reflective or non-reflective in just one pass through the “printing” station. Some of the advancements described herein are due to recent developments in metallic ink technology, gearless technology, sleeve technology, electron beam technology, UV technology, and temperature control technology.

The present invention makes it possible to produce surface reliefs at the same speeds and widths of conventional printing systems, and in perfect register to conventional printing systems. The surface reliefs can now be printed in any localized location of the substrate and in perfect register to the printing of any of the other printing stations. Applications for this technology include, but are not limited to: (1) flexible packaging; (2) rigid packaging; (3) shrink wrap films; (4) labels; (5) security documents such as continuous forms; (6) retroreflective structures; (7) non-reflective structures; (8) online lenticular printing; (9) intelligent substrates such as self cleaning substrates; (10) radio frequency identification products; (12) plastic chips; (13) micro-analysis systems; (14) optical components; (15) medical applications; (16) polymer displays; and (17) solar panels.

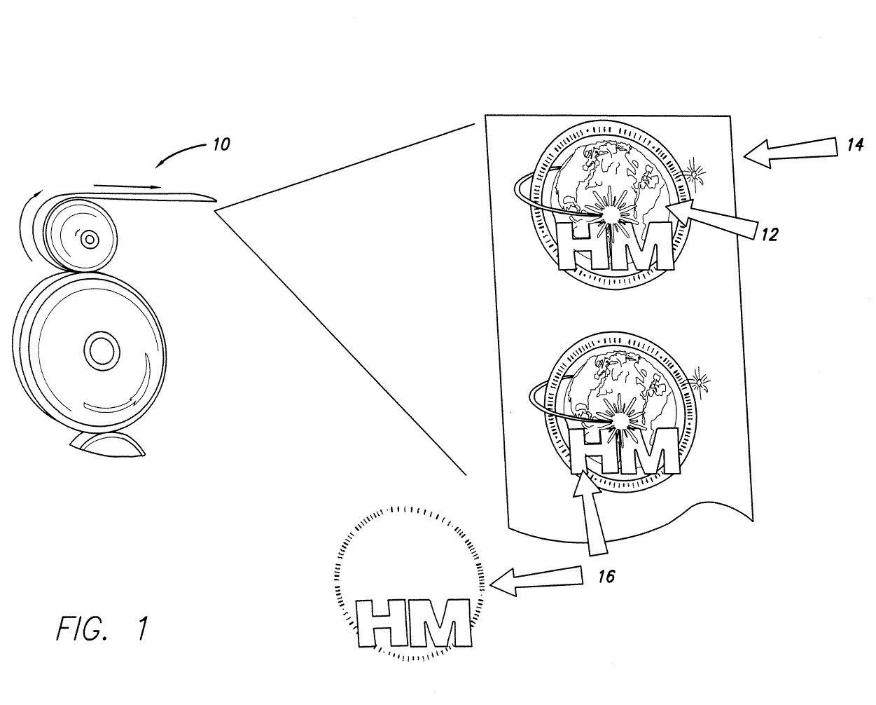

Referring to FIG. 1, conventional printing equipment 10 is used to print conventional ink-based images 12 onto a substrate 14. In accordance with the principles of the present invention, conventional printing equipment 10 is also used to print surface relief structures 16 onto substrate 14. Surface reliefs 16 can be printed on many different types of substrates, including, but not limited to: (1) plastic film; (2) paper; (3) synthetic paper; (4) boards; (5) aluminum foil; and (6) metallic sheets. Depending upon the type of substrate and coatings employed, surface reliefs 16 may be reflective, partially reflective or non-reflective. Additionally, the surface reliefs may be cast or cured with any type of UV/EB substances, such as: (1) metallic ink; (2) transparent ink; (3) dielectric ink and/or lacquer; (4) pearlecent ink and/or lacquer; (5) thermochromic ink and/or lacquer; (6) conductive ink and/or lacquer; (7) ink made with holographic powder; and (8) other types of UV/EB-based substances for creating visual effects and security applications.

Any of the above-identified UV/EB surface relief substances may be coated with a variety of colored translucid coatings for creating a wide range of structures for labeling and security applications. Such security applications may be used for printing currency, government documents, passports, and other security documents. According to further embodiments of the invention, a UV/EB curable and transparent high refractive index material may be used as the coating. Alternatively, high refractive index solvent and water based inks and or lacquers may be used as the coating. Additionally, transparent curable ink may be applied on top of, or below, a high refractive index coating. Advantageously, the use of high refractive index transparent inks and lacquers prevents the resulting structure from becoming invisible when overprinted or overlaminated. Otherwise, an expensive vacuum metallizer must be employed to apply a high refractive index coating to the holography so it does not become invisible.

Many nano-, micro-, and macro-structures include surface reliefs that are reflective. Holograms are one example of a reflective surface relief, which requires expensive metallizing equipment that is difficult to integrate with conventional printing systems. In addition, the manufacturing rate of reflective surface reliefs is traditionally extremely slow. According to an aspect of the invention, a radiation curable coating that incorporates reflective particles is applied to nano-, micro- and macro-structures in a single pass rather than two separate operations. A suitable radiation curable coating is a UV/EB ink or lacquer comprising: (1) metallic particles or flakes that become aligned substantially parallel to the surface of the substrate upon curing; and (2) a high refractive index coating mixed with the particles to brighten the nano-, micro-, and macro-structures. The resultant structures will reflect light and feature a metallic appearance.

Metallic high refractive inks, lacquers, and other metallic coatings preferably are used in the UV/EB curing applications of the present invention in order to make the resulting structures reflective. Particularly, the metallic coating is cured while the substrate is wrapped against a surface relief tool, thereby increasing the speed and efficiency of the curing process. When using an electron beam curing process, the composition of the substrate will not affect the ability of the electrons to pass through the substrate to cure the metallic coating.

The surface relief tool includes a surface relief that is substantially leveled such that there are no raised areas. The surface relief tool preferably includes localized surface reliefs on its area that may be identical to each other or different from each other. According to some embodiments of the invention, the surface relief tool is attached to a chilled drum. The surface relief tool may comprise a nickel sleeve, a nickel plate, an etched metallic drum, a clear plastic film or a clear plastic plate.

The metallic high refractive coating will conform to the surface relief on the embossing tool, thereby making a substantially exact copy of the surface relief features at high speed. Therefore, it is not necessary to emboss or cast the hologram at a first station and then apply the reflective or refractive coating at a second station. Advantageously, both the embossing/casting step and the application of the coating step are accomplished in one pass at a single station.

According to another aspect of the invention, a chilling station is used to help cure the UV/EB metallic high refractive coating against the surface relief tool in a single curing step. The resulting decrease in curing temperature prevents substrate and surface relief distortions that are common when using prior art systems. Particularly, it is important to be able to control temperatures in the process rollers to permit proper curing of surface relief with minimal distortion of the surface relief and the substrate to which the surface relief is attached.

According to an additional aspect of the invention, surface relief technology is provided that is compatible with reverse printing techniques that are widely used in the printing industry. One advantage of reverse printing is that the ink is protected because it never exposed. Electron beam curable equipment for reverse printing has come down in price considerably in recent years, such that it is economically feasible to install this technology on printing equipment for printing continuous forms, flexible packaging materials, rigid packaging materials, labels, and other printed products.

Due to advances in gearless press technology, it is possible to have substantially perfect registration among multiple print stations without the use of obsolete registration systems such as registration compensators. Gearless systems facilitate the installation of such a UV/EB station in printing systems, such as including: (1) flexographic equipment; (2) rotogravure equipment; (3) offset equipment; (4) continuous form equipment; (5) digital printing equipment; (6) silkscreen equipment; (7) lithographic equipment; (8) letterpress equipment; and (9) ink jet printing.

The preferred printing machine for printing surface reliefs in accordance with the principles of the invention comprises a gearless machine that ensures substantially perfect registration between printing stations and the curing tool station. Each roller in the printing machine preferably is controlled by a servomotor that is operated using a programmable logic controller, such that each roller is substantially perfectly synchronized and in register with the other rollers. With a gearless machine, it is possible to have different printing lengths without changing the diameters of the cylinders. Although the preferred printing equipment of the present invention is gearless, it should be evident to one of ordinary skill in the art that the invention may be practiced using gear presses without departing from the scope of the invention.

According to some embodiments of the invention, the thickness of the metallic high refractive index coating may be varied along a continuum from very thin to very thick, depending upon the desired effect of the end product. Advantageously, the variable-thickness feature of the invention permits the creation of see-through holograms for packaging and security applications.

According to an additional aspect of the invention, nano-, micro-, and macro-structures are capable of being printed using conventional printing methods, thus enabling printing at high speeds, at required widths, and in register with any conventional printing on the document or label being printed. Such structures include, but are not limited to: (1) electron beam generated holograms; (2) dot matrix holograms; (3) computer generated holograms; (4) optically variable devices (OVDs); (5) diffractive optical variable devices (DOVDs); (6) lenses; (7) lenticular lenses; (8) non-reflective structures; (9) light management structures; (10) deep structures (e.g., structures that diffract only one wavelength at a very wide viewing angle, such as found in some butterflies and other insects); (11) radio frequency identification (RFID) antennas; (12) embossable computer chips; (13) retroreflective structures; (14) metallic-looking structures; (15) wood textures; (16) leather textures; and (17) textile textures.

According to a preferred implementation of the invention, flexographic printing equipment is employed to apply the curable coating to the substrate. Alternatively, rotogravure equipment, offset equipment, continuous form equipment, digital printing equipment, letterpress equipment, ink jet equipment and other systems may be employed to apply the curable coating. Additionally, metallic or non-metallic high-diffractive index inks or lacquers are used instead of vacuum deposited aluminum.

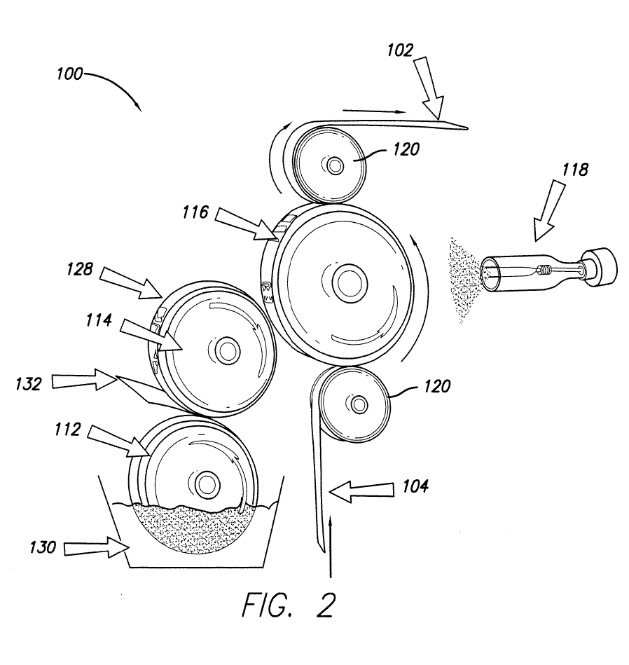

Referring to FIG. 2, a preferred system 100 of printing surface relief structures 102 on a substrate 104 using conventional printing equipment will now be described. The system 100 comprises anilox roller 112, flexographic tool 114, surface relief tool 116, curing tool 118 and printing rollers 120. Flexographic tool 114 preferably comprises a flexographic printing sleeve or plate attached to a master roller that is chilled to a predetermined temperature. The flexographic tool facilitates the transfer of complex shapes (raised sections 128) onto surface relief tool 116. Raised sections 128 substantially comprise an exact copy and location of the sections on surface relief tool 116 where the surface relief structures are placed. For example, flexographic tool 114 may include raised areas 128 provided with a metallic high refractive index coating for transferring the topography of raised areas 128 onto precise sections of surface relief tool 116. The creation of raised sections on the surface relief tool itself would be far more difficult and prohibitively expensive.

The system 100 further comprises a temperature-controlled tray 130 for the high refractive index material that forms the coating. Temperature-controlled tray 130 is designed to feed anilox roller 112, which carries the high refractive index material onto flexographic tool 114. The raised features of flexographic tool 114 pick up the high refractive index material from anilox roller 112. A doctor blade 132 may be provided for wiping excess ink away from raised areas 128 of flexographic tool 114. One advantage of using a high refractive index coating is that an adhesive, ink or additional coating may be applied to the cured coating without making the image disappear or become dimmer or distorted, regardless of the refractive index of the adhesive, ink or additional coating. A further advantage of using a high refractive index coating is that such a coating enhances the holography since it inherently reflects more light than a conventional thin clear coating, thereby increasing the brightness and definition of the resultant holographic image.

Anilox roller 112 is maintained at the predetermined temperature in order to induce the metallic particles within the high refractive index material to align substantially parallel to the major surface of the substrate. Anilox roller 112 may be heated or chilled depending on the printing configuration needed for a specific substrate. For example, anilox roller 112 may be heated to help the metallic particles in the metallic high refractive coating accommodate before curing. In addition, the master roller to which the flexographic sleeve is attached may be heated in order to preserve a selected temperature before curing.

In operation, raised areas 128 on flexographic tool 114 deposit the high refractive index coating onto the surface of surface relief tool 116 in substantially perfect register to the surface reliefs in surface relief tool 116. The substrate is fed between surface relief tool 116 and printing rollers 120 such that substrate 104 is pressed against surface relief tool 116. Thus, the high refractive index coating is pressed against surface relief tool 116 as it is being cured in a single pass by curing tool 118. According to a preferred implementation of the invention, curing tool 118 provides electromagnetic radiation, such as ultra-violet radiation treated with a beam of high energy electrons (UV/EB), for cuing the coating in a single pass. As would be understood by those of ordinary skill in the art, other types of electromagnetic radiation may be used for curing the coating in a single pass without departing from the scope of the present invention.

Surface relief tool 116 comprises localized areas having surface relief features that correspond with a very high degree of precision to the location of the areas of refractive index material on flexographic tool 114. The surface relief tool may comprise a nickel surface relief sleeve, a nickel plate and/or a clear embossed plastic plate that is attached to a chilled casting roller in order to maintain the substrate at a predetermined temperature, which is selected based on the type of substrate being employed as well as the process speed. If the surface relief tool is a sleeve, the chilled casting roller is slid into the sleeve, whereas if the surface relief tool is a plate, the chilled casting roller is clamped to the plate. Advantageously, the chilled casting roller ensures that the surface relief tool imparts a substantially exact copy of the surface relief onto the substrate, at room temperature with no major distortions to either the substrate or the surface relief. Curing tool 118 cures the coating in a single pass as the substrate is pressed against surface relief tool 116.

According to some embodiments of the invention, the printing on the substrate overlaps the surface relief in substantially perfect register. According to other embodiments of the invention, the printing on the substrate does not overlap the surface relief pattern. According to further embodiments, the printing and/or surface relief may be provided as a continuous wallpaper pattern with no registration requirement. Additionally, the printing and/or surface relief may be printed on either major surface of the substrate.

The high refractive index coating within temperature-controlled tray 130 may include metal particles for producing a metallic coating. Aluminum is one suitable material for the metal particles. When curing the metallic coating, the metal particles must be aligned substantially parallel to the substrate or the product will not be reflective. In order to correctly align the particles, the metallic coating is heated to a predetermined temperature that allows the particles to settle substantially parallel to the substrate, such that the particles follow the contour of the surface relief. As discussed hereinabove, the metallic coating is cured using curing tool 118 while substrate 104 is being pressed against surface relief tool 116 by printing rollers 120. Once cured, the metallic coating is adhered to substrate 104, which is easily separated from surface relief tool 116. The substrate will then exhibit surface reliefs that are a substantially exact copy of the surface reliefs on surface relief tool 116.

Many prior art holography systems rely on applying a metallic hot-stamping foil, hard embossing using both heat and pressure. The preferred system of printing surface reliefs structures of the present invention includes a number of advantages over such prior art systems. One advantage of the system of the present invention is that there is no external heat or pressure source required. A further advantage is that there is no visible distortion of the substrate and no visible loss of resolution of original image, when using the system of the present invention. An additional advantage involves the creation of brighter image than conventional systems. Moreover, the system of the invention involves minimal wear and tear of the surface relief tool, as compared with prior art systems.

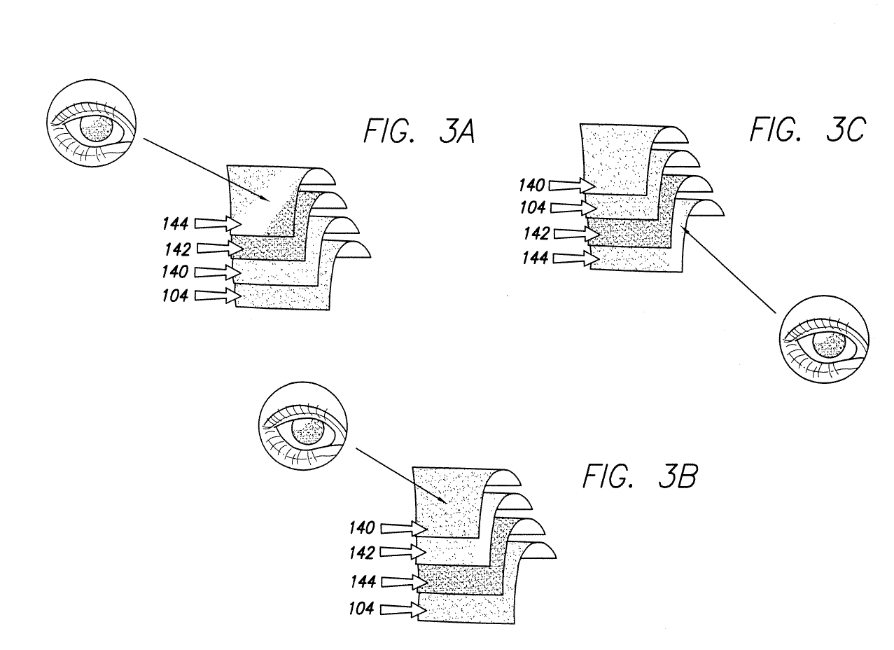

Referring to FIG. 3A, according to a preferred embodiment of the invention, a metallic base layer 140 (e.g., a metallic coating, hot-stamp metallic foil or cold-stamp metallic foil) is initially applied to substrate 104. Then, metallic base layer 140 is coated with a high refractive index material layer 142 having surface relief structures 144. After curing, the resultant surface relief structure will have an image featuring excellent brightness and definition. Metallic base layer 140 may be used in conjunction with a transparent high refractive index coating. Particularly, metallic base layer 140 is applied to the substrate, and then the transparent high refractive index coating with the holographic structure is cured on top of the metallic coating. Advantageously, the transparent high refractive index coating is conducive to both printing and reverse-printing the holography and inks. Referring to FIG. 3B, according to an alternative embodiment of the invention, high refractive index material layer 142 having surface relief structures 144 is initially cured onto the substrate, and then metallic base layer 140 is applied on top of high refractive index material layer 142. The resultant surface relief structure will be visible with excellent brightness and definition.

Similar to the embodiment of FIG. 3A, a transparent high refractive index coating may be employed as layer 142. The resultant image is visible in reverse printing with excellent brightness and sharpness characteristics. Referring to FIG. 3C, according to another alternative embodiment of the invention, metallic base layer 140 is applied to one major surface of substrate 104. The opposite major surface of substrate 104 is coated with a high refractive index material layer 142 having surface relief structures 144. The metallic ink is cured in a similar manner as the surface relief structures are cured. More particularly, the metallic ink and surface relief structures are cured by wrapping the substrate against the embossing tool, and then curing the metallic ink and surface relief structures through the substrate.

Another method for producing reflective surface relief structures involves: (1) applying metallic ink and or lacquer that it is cured against a mirror finish chilled roller at a first station; and (2) applying a high reflective index ink and/or lacquer that is cured on top of the mirror finish at a second station. Particularly, since the roller has a mirror finish, the metallic ink will become a mirror finish as well. Any type of texture in the macro relief may be imparted onto the mirror finish flexographic roller, and any type of texture may be imparted onto the metallic UV/EB inks (e.g., brushed films, polished aluminum surfaces and engraved stamping dies). The imparting of texture may be used in the production of labels, packaging, shrinkable films, greeting cards, and other products. The application of texture to the mirror finish may require the use of an additional curing tool.

Alternatively hot-stamping or cold-stamping metallized foils may be used as the mirror base at the first station, and then the high reflective index ink and/or lacquer is cast and applied onto the already placed metallic finish. The hot-stamping is applied at the first station with a hot-stamping rotary attachment using heat and pressure, whereas the cold-stamping is applied on the first station by first applying a cold stamping adhesive and laminating the foil to it. In either case, the foils are applied to the surface of the substrate in the exact shape and location that the holography will have on top of them.

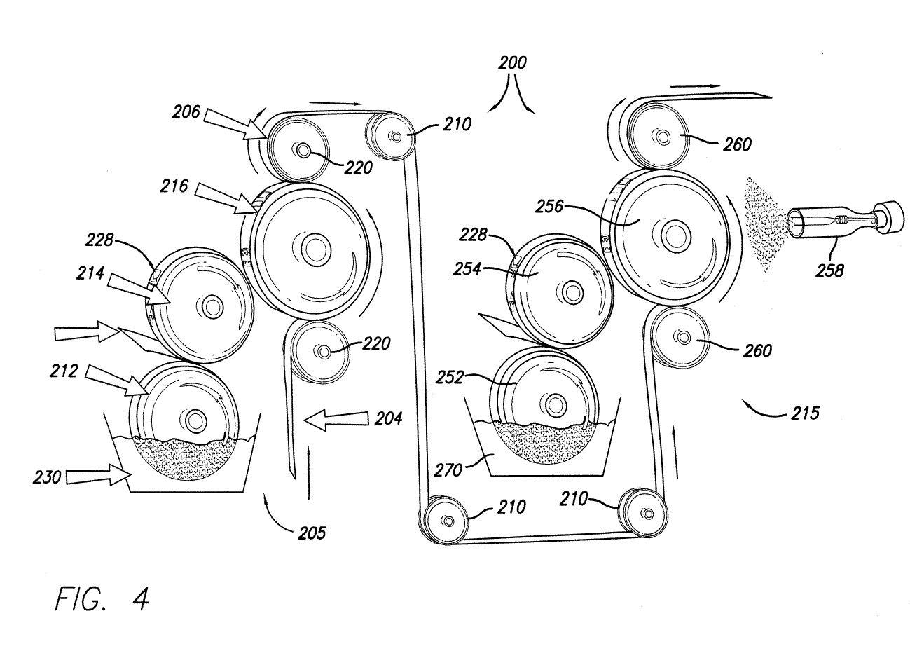

Referring to FIG. 4, a preferred system 200 of printing mirrored surface relief structures on a substrate 204 using conventional printing equipment will now be described. The system 200 comprises a first printing station 205 for applying a mirrored finish 206 to substrate 204, and a second printing station 215 for curing surface relief structures 228 on top of mirrored finish 206. The first and second printing stations are interconnect by a web including substrate 204 and rollers 210. First printing station 205 comprises anilox roller 212, flexographic tool 214, temperature controlled mirror finish roller 216, printing rollers 220 and temperature-controlled tray 230, whereas second printing station 215 comprises anilox roller 252, flexographic tool 254, surface relief tool 256, curing tool 258, printing rollers 260 and temperature-controlled tray 270.

Flexographic tools 214, 254 preferably each comprise a flexographic printing sleeve or plate attached to a master roller that is temperature controlled to a predetermined temperature. Flexographic tool 254 facilitates the transfer of complex shapes (raised sections 228) onto surface relief tool 256. Temperature-controlled tray 230 is designed to feed anilox roller 212, which carries a metallic ink that will be cured against mirror finish roller 216. Temperature-controlled tray 270 is designed to feed anilox roller 252, which carries a high refractive index material onto flexographic tools 214, 254, respectfully. In operation, raised areas 228 on flexographic tool 254 deposit the high refractive index coating onto the surface of surface relief tool 256 in substantially perfect register to the surface reliefs in surface relief tool 256. The substrate is fed between surface relief tool 256 and printing rollers 260 such that the high refractive index coating is pressed against surface relief tool 256 as it is being cured by curing tool 258.

The system of FIG. 4 may be used for “pad printing” or tampography, wherein a metallic base is applied at the first station, and a surface relief structure with a refractive index coating is applied at the second station. The use of pad printing or tampography allows the surface relief structures to be imparted onto objects having intricate shapes. Otherwise, the surface relief structures may only be imparted on substantially flat substrates.

Shrinkable films tend to be extremely sensitive to heat, tension, and pressure. A further application of the principles of the present invention concerns the production of shrinkable films having print and holography that are in register, without causing the films to shrink and/or distort. In some prior art systems, the holography is transferred to the shrinkable film using a transfer process. By contrast, in accordance with the principles of the present invention, the film is printed using conventional printing equipment. Specifically, at a first printing station, a metallic coating is applied to a substrate, and at a second printing station, the holographic structure is cured on top of the metallic surface using a high refractive index lacquer. Alternatively, other metallic or non-metallic high refractive index coatings may be employed instead of the high refractive index lacquer.

Thus, it is seen that systems and methods for printing surface relief structures are provided. One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

What is claimed is:

1. A system for printing surface relief structures onto a substrate, the system comprising:
an anilox roller carrying a high refractive index material;
a surface relief tool;
a flexographic tool including raised features for picking up the high refractive index material from the anilox roller and depositing the high refractive index material onto the surface relief tool; and
a curing tool that cures the high refractive index material in a single pass as the substrate is pressed against the surface relief tool.

2. The system of claim 1, wherein the surface relief tool includes a chilled casting roller for maintaining the substrate at a predetermined temperature.

3. The system of claim 1, wherein the high refractive index material includes metal particles for producing a metallic coating.

4. The system of claim 3, wherein the high refractive index material including metal particles is heated to a predetermined temperature that allows the particles to settle substantially parallel to the substrate when being cured.

5. The system of claim 1, wherein the curing tool is used to direct an electron beam or UV/EB through the substrate as the substrate is being chilled.

6. The system of claim 1, wherein the flexographic tool deposits the high refractive index material onto the surface relief tool in substantially perfect register to the surface relief structures in the surface relief tool.

7. The system of claim 1, wherein the anilox roller is maintained at a predetermined temperature in order to induce metallic particles within the high refractive index material to align substantially parallel to a major surface of the substrate.

8. The system of claim 1, further comprising a temperature-controlled tray containing the high refractive index material, wherein the temperature-controlled tray is designed to feed the anilox roller.

9. The system of claim 1, wherein the flexographic tool comprises a flexographic printing sleeve or plate attached to a temperature controlled master roller.

10. The system of claim 1, wherein the substrate is chosen from the group consisting of: plastic film; paper; synthetic paper; boards; aluminum foil; and metallic sheets.

11. The system of claim 1, wherein the high refractive index material comprises a UV/EB ink or lacquer including metallic particles that become aligned substantially parallel to the surface of the substrate upon curing.

12. The system of claim 1, wherein the surface relief tool is selected from the group consisting of: a nickel sleeve; a nickel plate; an etched metallic drum; a clear plastic film; a clear embossed plastic plate; and a clear plastic plate.

13. The system of claim 1, wherein the system comprises a gearless machine controlled by a servomotor that ensures substantially perfect registration.

14. The system of claim 1, wherein the surface relief structures may be printed on either major surface of the substrate.

15. The system of claim 1, wherein the high refractive index material is dielectric, pearlescent, thermochromic, conductive, or holographic.

16. The system of claim 1, wherein the surface relief structures are printed such that they overlap ink printing on the substrate in substantially perfect register.

17. The system of claim 1, wherein the surface relief structures are printed as a continuous wallpaper pattern with no registration requirement.

18. A method for producing reflective surface relief structures comprising the steps of:
applying a metallic coating that it is cured against a mirror finish chilled flexographic roller at a first station; and
applying a high reflective index coating that is cured with its surface relief on top of the mirror finish at a second station.

19. The method of claim 18, further comprising the step of imparting a texture onto the mirror finish flexographic roller.

20. The method of claim 18, wherein the surface relief structures are between 10 nanometers and 3 millimeters in depth and width.
